(19) United States
(12) Patent Application Publication
(10) Pub. No.: US 2023/0239356 A1
(43) Pub. Date: Jul. 27, 2023

(54) INTERACTION CONTROLS IN ARTIFICIAL REALITY

(71) Applicant: Meta Platforms Technologies, LLC, Menlo Park, CA (US)

(72) Inventors: Jasmine Soria Sears, Kirkland, WA (US); Brandon Michael Hellman Friedman, Redmond, WA (US); Barry David Silverstein, Kirkland, WA (US)

(21) Appl. No.: 18/156,302

(22) Filed: Jan. 18, 2023

Related U.S. Application Data
(60) Provisional application No. 63/301,973, filed on Jan. 21, 2022.

(51) Int. Cl. H04L 67/131; G06T 19/00

(52) U.S. Cl. CPC H04L 67/131; G06T 19/006

(57) ABSTRACT

Various aspects of the subject technology relate to systems, methods, and machine-readable media for interaction controls in artificial reality. Various aspects may include determining at least one element corresponding to a user device for accessing a shared artificial reality environment. Aspects may also include determining at least one artificial reality setting associated with the shared artificial reality environment. Aspects may include receiving an indication of a permission event associated with a permitted user or a temporal parameter. Aspects may include determining whether to enable or disable the at least one element or at least one artificial reality setting based on the permission event. The aspect may also include sending content to the user device based on the permission event.

### CROSS REFERENCE TO RELATED APPLICATIONS

This present application claims the benefit of priority under 35 U.S.C. § 119(e) to U.S. Provisional Application No. 63/301,973, filed Jan. 21, 2022, the disclosure of which is hereby incorporated by reference in its entirety for all purposes.

### TECHNICAL FIELD

The present disclosure generally relates to adjusting interactive user devices for artificial reality environments, and more particularly to changing user device usage modes depending on circumstances that restrict users from providing user input.

### BACKGROUND

Interaction between users of a computing system such as network environment or a computer generated shared artificial reality environment involves user input for interaction with various types of artificial reality/virtual content, elements, and/or applications in the shared artificial reality environment. Such artificial reality devices may require direct user input for artificial reality-based functions. However, certain circumstances can restrict user input such as religious beliefs, disabilities, and/or the like. For example, religious beliefs can prevent users from wearing artificial reality glasses, even if as conventional prescription glasses if such glasses require interfacing with electronics. In addition, such restrictions on user input can be based on time, such as a religious observance on a day of the week (e.g., Shabbat). Having artificial reality input output features being managed according to a programmable manager may enhance the artificial reality experience for those who have restrictions on user input.

### SUMMARY

The subject disclosure provides for systems and methods for controlling interaction in an artificial reality environment. The disclosure address the problem of controlling interaction in the artificial reality environment that may comprise remote users by providing a permission manager mechanism. One embodiment of the disclosure relates to a method controlling the interaction. The method includes determining at least one element corresponding to a user device for accessing a shared artificial reality environment. The method includes determining at least one artificial reality setting associated with the shared artificial reality environment. The method further includes receiving an indication of a permission event associated with a permitted user or a temporal parameter. The method includes determining whether to enable or disable the at least one element or at least one artificial reality setting based on the permission event. The method also includes sending content to the user device based on the permission event.

Another aspect of the present disclosure relates to a system configured for controlling interactions in an artificial reality environment. The processor(s) can determine at least one element corresponding to a user device for accessing a shared artificial reality environment. The processor(s) can determine at least one artificial reality setting associated with the shared artificial reality environment. The processor(s) can receive an indication of a permission event associated with a permitted user or a temporal parameter. The processor(s) can determine whether to enable or disable the at least one element or at least one artificial reality setting based on the permission event. The processor(s) can transmit content to the user device based on the permission event.

Yet another aspect of the present disclosure relates to a non-transient computer-readable storage medium having instructions embodied thereon, the instructions being executable by one or more processors to control interactions in an artificial reality environment. The method includes determining at least one element corresponding to a user device for accessing a shared artificial reality environment. The method includes determining at least one artificial reality setting associated with the shared artificial reality environment. The method further includes receiving an indication of a permission event associated with a permitted user or a temporal parameter. The method includes determining whether to enable or disable the at least one element or at least one artificial reality setting based on the permission event. The method also includes sending content to the user device based on the permission event.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of a device operating environment with which aspects of the subject technology can be implemented.

FIGS. 2A-2B are diagrams illustrating virtual reality headsets, according to certain aspects of the present disclosure.

FIG. 2C illustrates controllers for interaction with an artificial reality environment, according to certain aspects of the present disclosure.

FIG. 3 is a block diagram illustrating an overview of an environment in which some implementations of the present technology can operate.

FIG. 4 is a block diagram illustrating an example computer system (e.g., representing both client and server) with which aspects of the subject technology can be implemented.

FIG. 5 is an example flow diagram for navigation through a shared artificial reality environment, according to certain aspects of the present disclosure.

FIG. 6 is a block diagram illustrating an example computer system with which aspects of the subject technology can be implemented.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

The subject disclosure provides for a centralized and programmable permission manager for managing software and hardware compatible with or used to facilitate use of a shared artificial reality environment. For example, the software and hardware can be selectively enabled or disabled by the permission manager. Allowable content in the environment can be limited according to a scheduler or authorized remote user controlling the permission manager. The software and hardware being managed can be camera, microphone, display, speaker, artificial reality motion parameters, artificial reality eye contact parameters, etc. for example. As an example, the hardware being managed can be hardware of an artificial reality compatible device such as an augmented reality device, a video-to-video screen chat capable XR device, and/or the like. In particular, the scheduler implemented by the permission manager can be bound by different criteria such as time bound, location bound, situation bound, health bound, motion bound, and/or the like in the artificial reality environment. Permissions for various artificial reality software and hardware features can be recommended to users, such as based on a machine learning model. User requests can be used to restrict such software and hardware features, including by authorized users using remote access to limit, control access to, or otherwise configure the features. Moreover, scheduled events may also be used to set, change, or otherwise control permission for the features. Accordingly, users may experience a better experience in the artificial reality environment that is tailored to user abilities (e.g., when and what user inputs that users are capable of generating).

The disclosed system addresses a problem in artificial reality tied to computer technology, namely, the technical problem of variable limits on user inputs for interaction in a computer generated shared artificial reality environment. The disclosed system solves this technical problem by providing a solution also rooted in computer technology, namely, by providing a permission manager mechanism according to events or other bounds and/or other authorized users. The disclosed system also improves the functioning of the computer used to generate the artificial reality environment because it enables the computer to improve user interaction for variable limits on user interaction capabilities. For example, the permission manager mechanism can change what type of inputs can be received or used via an artificial reality environment. Accordingly, the present invention is integrated into a practical application of computer based artificial reality environments because motion parameters, navigation parameters, and other parameters specific to such environments can be modulated depending on sensed or externally programmed user input characteristics (e.g., permissions managed by a third party). In particular, the disclosed system provides more responsive, natural, and effective interaction with the artificial reality environment by enabling or disabling specific artificial reality features depending on specifically determined user characteristics or third-party instructions for particular users. Third party instructions can enable certain trusted parties (e.g., parents of children) to have access and/or grant permissions for such artificial reality features, such as for particular people and/or periods of time.

Aspects of the present disclosure are directed to creating and administering artificial reality environments. For example, an artificial reality environment may be a shared artificial reality environment, a virtual reality (VR), an augmented reality environment, a mixed reality environment, a hybrid reality environment, a non immersive environment, a semi-immersive environment, a fully immersive environment, and/or the like. As used herein, “real-world” objects are non-computer generated and artificial or VR objects are computer generated. For example, a real-world space is a physical space occupying a location outside a computer and a real-world object is a physical object having physical properties outside a computer. For example, an artificial or VR object may be rendered and part of a computer-generated artificial environment. The artificial environments may also include collaborative, gaming, working, and/or other environments which include modes for interaction between various people or users in the artificial environments. The artificial environments of the present disclosure may have features that are selectively enabled or disabled based on user input characteristics, such as motion characteristics, health/biometric characteristics, and/or the like.

Embodiments of the disclosed technology may include or be implemented in conjunction with an artificial reality system. Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some implementations, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real-world. For example, an AR headset could be shaped as a pair of glasses with a pass-through display, which allows light from the real-world to pass through a waveguide that simultaneously emits light from a projector in the AR headset, allowing the AR headset to present virtual objects intermixed with the real objects the user can see. The AR headset may be a block-light headset with video pass-through. “Artificial reality,” “extra reality,” or “XR,” as used herein, refers to any of VR, AR, MR, or any combination or hybrid thereof.

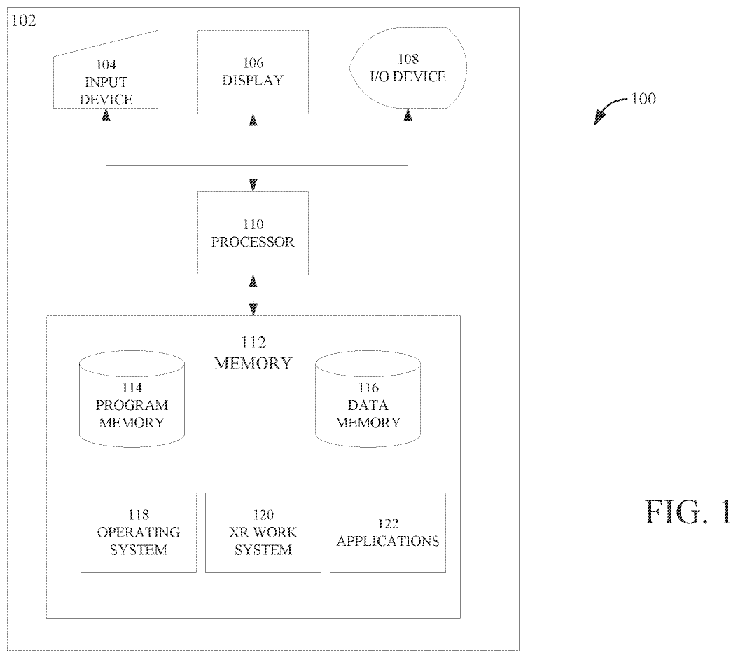

Several implementations are discussed below in more detail in reference to the figures. FIG. 1 is a block diagram of a device operating environment 100 with which aspects of the subject technology can be implemented. The device operating environment can comprise hardware components of a computing system 100 that can create, administer, and provide interaction modes for a shared artificial reality environment (e.g., gaming artificial reality environment) such as for individually control of audio (e.g., switching audio sources) via XR elements and/or real-world audio elements. The interaction modes can include different audio sources or channels for each user of the computing system 100. Some of these audio channels may be spatialized or non-spatialized. In various implementations, the computing system 100 can include a single computing device or multiple computing devices 102 that communicate over wired or wireless channels to distribute processing and share input data.

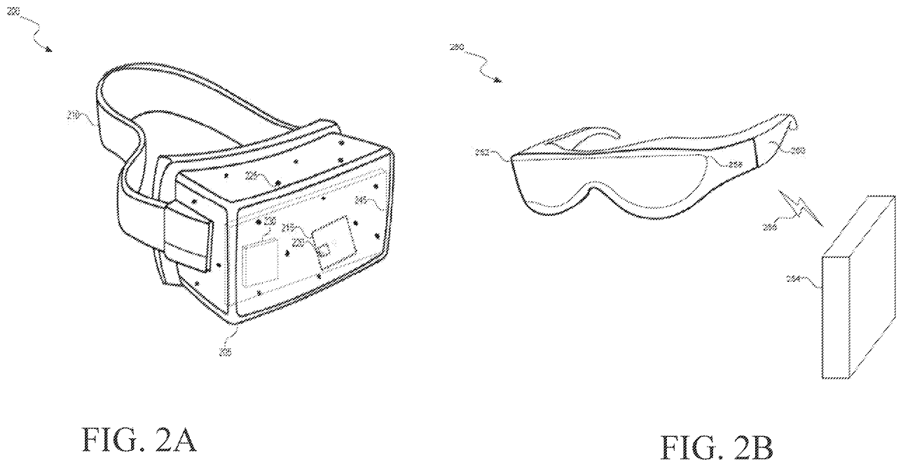

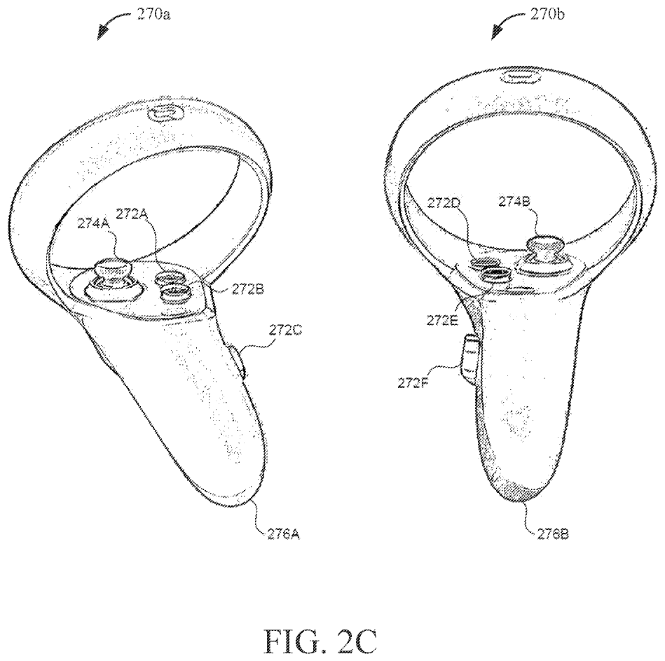

In some implementations, the computing system 100 can include a stand-alone headset capable of providing a computer created or augmented experience for a user without the need for external processing or sensors. In other implementations, the computing system 100 can include multiple computing devices 102 such as a headset and a core processing component (such as a console, mobile device, or server system) where some processing operations are performed on the headset and others are offloaded to the core processing component. Example headsets are described below in relation to FIGS. 2A-2B. In some implementations, position and environment data can be gathered only by sensors incorporated in the headset device, while in other implementations one or more of the non-headset computing devices 102 can include sensor components that can track environment or position data, such as for implementing computer vision functionality. Additionally or alternatively, such sensors can be incorporated as wrist sensors, which can function as a wrist wearable for detecting or determining user input gestures. For example, the sensors may include inertial measurement units (IMUs), eye tracking sensors, electromyography (e.g., for translating neuromuscular signals to specific gestures), time of flight sensors, light/optical sensors, and/or the like to determine the inputs gestures, how user hands/wrists are moving, and/or environment and position data. Such sensors can be selectively enabled or disabled depending on user input restrictions and/or inputs from authorized/permissioned remote users for a particular subject user.

The computing system 100 can include one or more processor(s) 110 (e.g., central processing units (CPUs), graphical processing units (GPUs), holographic processing units (HPUs), etc.) The processors 110 can be a single processing unit or multiple processing units in a device or distributed across multiple devices (e.g., distributed across two or more of computing device 102). The computing system 100 can include one or more input devices 104 that provide input to the processors 110, notifying them of actions. The actions can be mediated by a hardware controller that interprets the signals received from the input device 104 and communicates the information to the processors 110 using a communication protocol. As an example, the hardware controller can translate signals from the input devices 104 to render audio, motion, or other signal controlled features in the shared XR environment. Each input device 104 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, and/or other user input devices.

The processors 110 can be coupled to other hardware devices, for example, with the use of an internal or external bus, such as a PCI bus, SCSI bus, wireless connection, and/or the like. The processors 110 can communicate with a hardware controller for devices, such as for a display 106. The display 106 can be used to display text and graphics. In some implementations, the display 106 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and/or the like. Other I/O devices 108 can also be coupled to the processor, such as a network chip or card, video chip or card, audio chip or card, USB, firewire or other external device, camera, printer, speakers, CD-ROM drive, DVD drive, disk drive, etc.

The computing system 100 can include a communication device capable of communicating wirelessly or wire-based with other local computing devices 102 or a network node. The communication device can communicate with another device or a server through a network using, for example, TCP/IP protocols. The computing system 100 can utilize the communication device to distribute operations across multiple network devices. For example, the communication device can function as a communication module. The communication device can be configured to transmit or receive audio signals.

The processors 110 can have access to a memory 112, which can be contained on one of the computing devices 102 of computing system 100 or can be distributed across one of the multiple computing devices 102 of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. The memory 112 can include program memory 114 that stores programs and software, such as an operating system 118, XR work system 120, and other application programs 122 (e.g., XR games). The memory 112 can also include data memory 116 that can include information to be provided to the program memory 114 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, and/or the like.

FIGS. 2A-2B are diagrams illustrating virtual reality headsets, according to certain aspects of the present disclosure. FIG. 2A is a diagram of a virtual reality head-mounted display (HMD) 200. The HMD 200 includes a front rigid body 205 and a band 210. The front rigid body 205 includes one or more electronic display elements such as an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real-world and in a virtual environment in three degrees of freedom (3DoF), six degrees of freedom (6DoF), etc. For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points, such as for a computer vision algorithm or module. The compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof. The electronic display 245 can be coupled with an audio component, such as send and receive output from various other users of the XR environment wearing their own XR headsets, for example. The audio component can be configured to host multiple audio channels, sources, or modes.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by the link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc. The frame 260 or another part of the mixed reality HMD 252 may include an audio electronic component such as a speaker. The speaker can output audio from various audio sources, such as a phone call, VoIP session, or other audio channel. The electronic components may be configured to implement audio switching based on user gaming or XR interactions.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real-world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects. For example, the HMD system 250 can track the motion and position of user's wrist movements as input gestures for performing XR navigation. As an example, the HMD system 250 may include a coordinate system to track the relative positions of various XR objects and elements in a shared artificial reality environment. If such motion tracking is restricted by a permission manager according to user characteristics or input from a permissioned remote user, then this tracking functionality by the HMD system 250 can be deactivated for the corresponding user.

FIG. 2C illustrates controllers 270a-270b, which, in some implementations, a user can hold in one or both hands to interact with an artificial reality environment presented by the HMD 200 and/or HMD 250. The controllers 270a-270b can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. For example, the compute units 230 can use the monitored hand positions to implement navigation and scrolling via the hand positions and motions of the user.

The controllers 270a-270b can also include various buttons (e.g., buttons 272A-F) and/or joysticks (e.g., joysticks 274A-B), which a user can actuate to provide input and interact with objects. As discussed below, controllers 270a-270b can also have tips 276A and 276B, which, when in scribe controller mode, can be used as the tip of a writing implement in the artificial reality environment. In various implementations, the HMD 200 or 250 can also include additional subsystems, such as a hand tracking unit, an eye tracking unit, an audio system, various network components, etc. to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. Such camera based hand tracking can be referred to as computer vision, for example. Sensing subsystems of the HMD 200 or 250 can be used to define motion (e.g., user hand/wrist motion) along an axis (e.g., three different axes).

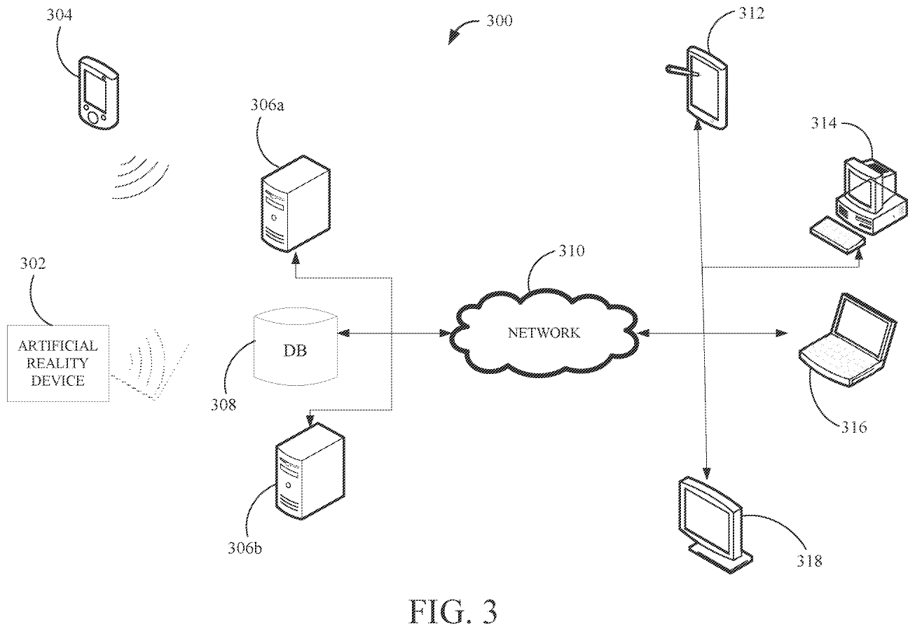

FIG. 3 is a block diagram illustrating an overview of an environment 300 in which some implementations of the disclosed technology can operate. The environment 300 can include one or more client computing devices, such as artificial reality device 302, mobile device 304 tablet 312, personal computer 314, laptop 316, desktop 318, and/or the like. The artificial reality device 302 may be the HMD 200, HMD system 250, a wrist wearable, or some other XR device that is compatible with rendering or interacting with an artificial reality or virtual reality environment. The artificial reality device 302 and mobile device 304 may communicate wirelessly via the network 310. In some implementations, some of the client computing devices can be the HMD 200 or the HMD system 250. The client computing devices can operate in a networked environment using logical connections through network 310 to one or more remote computers, such as a server computing device.

In some implementations, the environment 300 may include a server such as an edge server which receives client requests and coordinates fulfillment of those requests through other servers. The server may include server computing devices 306a-306b, which may logically form a single server. Alternatively, the server computing devices 306a-306b may each be a distributed computing environment encompassing multiple computing devices located at the same or at geographically disparate physical locations. The client computing devices and server computing devices 306a-306b can each act as a server or client to other server/client device(s). The server computing devices 306a-306b can connect to a database 308 or can comprise its own memory. Each server computing devices 306a-306b can correspond to a group of servers, and each of these servers can share a database or can have their own database. The database 308 may logically form a single unit or may be part of a distributed computing environment encompassing multiple computing devices that are located within their corresponding server, located at the same, or located at geographically disparate physical locations.

The network 310 can be a local area network (LAN), a wide area network (WAN), a mesh network, a hybrid network, or other wired or wireless networks. The network 310 may be the Internet or some other public or private network. Client computing devices can be connected to network 310 through a network interface, such as by wired or wireless communication. The connections can be any kind of local, wide area, wired, or wireless network, including the network 310 or a separate public or private network. In some implementations, the server computing devices 306a-306b can be used as part of a social network such as implemented via the network 310. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identifies a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

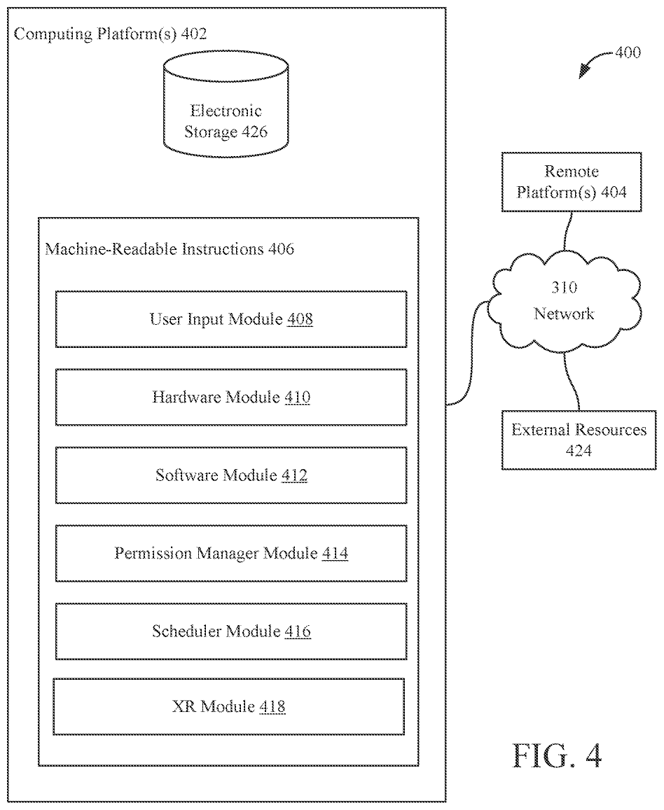

FIG. 4 is a block diagram illustrating an example computer system 400 (e.g., representing both client and server) with which aspects of the subject technology can be implemented. The system 400 may be configured for implementing tailored interaction controls for a shared artificial reality environment via XR compatible devices, according to certain aspects of the disclosure. The system 400 can include a centralized and programmable permission manager configured to enable or disable input/output hardware and/or software elements of the XR device and/or environment. The permission manager of the system 400 accordingly may control what content (e.g., XR content) is allowed to pass through to a particular user based on a scheduler or a permissioned remote user. The scheduler or remote user can configure permissions implemented by the permission manager according to capabilities, restrictions, or other characteristics corresponding to the particular user, such as visual impairments, age, religious beliefs, and/or the like. The system 400 can broadcast activation or deactivation of XR features via granted permission from the permission manager, which removes user input requirements for such activation or deactivation by the particular user. Advantageously, the particular user does not need to be an active local user, which can facilitate compliance with a religious prohibition against XR device interaction.

The permission manger can be a controller component of the system 400 that receives inputs from the scheduler or input from the permissioned remote user. As an example, the scheduler can allow some communication from a permission managed device at certain time(s). Thus, a hospitalized patient who cannot interact with an XR device by touching or speaking can still be communicated with, such as asynchronously via an initiated broadcast from another user during the scheduled certain time(s). Additionally or alternatively, another user can be a remote user with granted permission to allow/initiate communication or content via the XR device of the hospitalized patient. In general, the permission manager may selectively enable or disable XR features such as pass-through content, software features, automated events, etc. The permission manager may also selectively enable or disable input/output elements such as the camera, microphone, display, speaker, and/or the like of the XR device.

As discussed herein, the remote user can have permissions via the permission manager based on the remote user being a parent implementing parental controls. The parent controls can include a parent being a permission remote user that is able of turning on camera and/or GPS of the XR device to track their children, such as if a child is missing, or to send a message to their children (e.g., an automated broadcast activation to broadcast message of come into the house for dinner).

In some implementations, the system 400 may include one or more computing platforms 402. The computing platform(s) 402 can correspond to a server component of an artificial reality/XR platform, which can be similar to or the same as the server computing devices 306a-306b of FIG. 3 and include the processor 110 of FIG. 1. The computing platform(s) 402 can be configured to interact with XR compatible user devices even if not directly controlled by an active user of the computing platform(s) 402. For example, the computing platform(s) 402 may be configured to execute algorithm(s) to determine when to schedule or permit XR device interfacing without the active user. As an example, the XR compatible device (e.g., HMD 200, the HMD system 250) of the remote platforms 404 can be controlled according to a scheduler such as according to temporal bounds, motion bound, biometric bounds and/or the like. The parameters set for the scheduler can enable privacy controls as well as specific time points or criteria to activate or deactivate certain hardware or software features of the XR device. As an example, the user input of the active user can be substituted by XR device interfacing from a remote user with an asynchronous permission grant, such as a family member, caregiver, or other trusted user.

The computing platform(s) 402 may be configured to communicate with one or more remote platforms 404 according to a client/server architecture, a peer-to-peer architecture, and/or other architectures. The remote platform(s) 404 may be configured to communicate with other remote platforms via computing platform(s) 402 and/or according to a client/server architecture, a peer-to-peer architecture, and/or other architectures. Users may access the system 400 hosting the shared XR environment via remote platform(s) 404. In this way, the remote platform(s) 404 can be configured to cause output of a version of the shared XR environment for particular user representations corresponding to users using client device(s) of the remote platform(s) 404, such as via the HMD 200, HMD system 250, and/or controllers 270a-270b of FIG. 2C. As an example, the remote platform(s) 404 can access artificial reality content and/or artificial reality applications for use in the shared artificial reality for the corresponding user(s) of the remote platform(s) 404, such as via the external resources 424. The computing platform(s) 402, external resources 424, and remote platform(s) 404 may be in communication and/or mutually accessible via the network 150.

The computing platform(s) 402 may be configured by machine-readable instructions 406. The machine-readable instructions 406 may be executed by the computing platform(s) to implement one or more instruction modules. The instruction modules may include computer program modules. The instruction modules being implemented may include one or more of user input module 408, hardware module 410, software module 412, permission manager module 414, XR module 416, XR module 418, XR module 420, and/or other instruction modules. The computing platform(s) 402 and the remote platform(s) 404 can be configured to apply a VoIP implementation, a client-model, a server drive model, location mechanism, etc.

The user input module 408 can be used to determine restrictions, such as user input restrictions for interactive devices such as XR compatible devices for the shared XR environment. For example, the user input module 408 may determine whether a subject user is capable of providing input for a particular XR device that requires direct user input. As an example, the user input module 408 could determine that user input for the subject user is restricted because of disabilities (e.g., physical disabilities), a requirement for physical conscious presence, or a religious prohibition (e.g., religious refrainment from interfacing electronics on Shabbat). The user input module 408 can determine adjustments needed for limitations in user input. For example, for an XR glasses device, the user input module 408 and hardware module 410 can determine that that an XR based interface can address vision impairments.

The hardware module 410 may activate or deactivate features according to circumstances that restrict or otherwise impact user input. For example, the hardware module 410 may also always keep a prescriptive vision adjustment hardware feature (e.g., auto-dimming) of the XR glasses powered on while powering off other features such as eye tracking sensing for modeling user representation movement in the XR environment, the display component of the XR glasses, and/or the like. That is, the hardware module 410 may maintain the electronic prescription lenses portion of the XR glasses while deactivating other remaining electronic interacting components of the XR glasses. The hardware module 410 can similarly control access to other hardware features such as location tracking (e.g., GPS), motion tracking (e.g., accelerometer), lights, sensors, microphone, and/or the like. As an example, the internal lights of the XR glasses can be controlled by the hardware module 410 to automatically turn on when the subject user puts on the XR glasses on their face.

The software module 412 can activate or deactivate features according to circumstances that restrict or otherwise impact user input. For example, the software module 412 may initiate or allow communication for users that are incapable of initiating the call by pressing a start call button. The software module 412 and the permission manager module 414 can track scheduled times, events, or permissions as well as permissioned remote users to enable the activation of communication or other features. Software features controlled by the software module 412 may include XR applications, excluding certain XR content (e.g., parental controls), filtering out communication from other XR users, managing eye/hand tracking or navigation XR functionality, do not disturb setting (e.g., don't show certain notifications or options that could be sensitive for user health issues), and/or the like. For example, the software module 412 can control whether XR hand tracking or other navigation should be enabled or disabled and at what times.

The permission manager module 414 may grant permission for activating features on the XR compatible device such as communication. Permission may be granted on a scheduling basis or from a remote user. For example, the permission manager module 414 may grant access to a camera of the XR device at certain scheduled times, such as specific days or hours of the week. As an example, the subject user of the XR device can schedule permissions such that interacting with the XR device (or any companion device) does not trigger any LEDs or sensors of the XR device from sundown on Fridays to sundown on Saturdays. Additionally or alternatively, the permissions managed by the permission manager module 414 can be based on GPS location, calendar, clock data, etc. This limited level of permissions can be contrasted with normal use of the XR device (e.g., AR headset or glasses) in which the subject user could trigger a number of lights (e.g., turning on/off or changing the color of a standby/power/privacy/depth projector lights) and sensors (cameras, microphones, eye tracking sensors) by touching, picking up, donning, or doffing the XR device.

The permissions and scheduling parameters of the permission manager module 414 can be hard coded or can be suggested based on a machine learning algorithm/model or other artificial intelligence. For example, the machine learning model can suggest or recommend settings for granting or denying permission for various XR software or hardware features. Such setting can be XR settings (artificial reality settings) for activating or deactivating a software or hardware feature depending on the subject user's capabilities (e.g., limitations on the type of user input that the subject user can provide). The permission manager module 414 can provide an application for the subject user or permissioned remote users to set permissions and instructions for features, such as in case of emergency events. For example, if user A has a restriction on physically interfacing with the XR device, then the permission manager module 414 may be used so that user B has access to the video and microphone of the XR device enabled so that user A and B can talk without user A physically interfacing with the XR device. In particular, user B may be given permission by user A such that user B is a permission user to initiate a video call (e.g., such as at specific times) without requiring user A to accept the video call via the XR device so as to avoid physical interfacing.

The scheduler module 416 may schedule when various XR software or hardware features are allowed/activated or denied/deactivated. Such scheduling can be based on temporal bounds, biometric bounds, motion bounds, location bounds, and/or the like. In other bounds, such bounds can be used to determine when to allow permissions or activate versus when to deny permissions or deactivate specific permissions controlled by the permission manager module 414 and/or the scheduler module 416. The scheduler module 416 can set a timer such as to power down all features of the XR glasses except for the prescription corrective vision feature on Friday evening and Saturday evening of each week. The subject user can set the schedule implemented by the scheduler module 416 or another permissioned user may modify or otherwise control the schedule of the scheduler module 416. The scheduler module 416 may also set or change the schedule via bounds/thresholds based on characteristics of the subject user. For example, the bounds can include bounds based on health parameters, motion parameters, eye tracking parameters, time parameters, event parameters, and/or the like. In particular, the health parameters can include heart, oxygen, temperature, neural activity, chemical/biometric activity and or the like. Motion parameters can include accelerometer based motion by the subject user. Eye tracking parameters may include dilated eyes, pupil mismatch, etc., for example, as a sign of a health issue. Time and event parameters can include a specific time of day, emergency event, and/or a specific developing health event (e.g., based on the health parameters), such as a stroke.

The XR module 420 may be used to render the shared artificial reality environment for remote platform(s) 404 via the computing platform(s) 402, for example. The XR module 420 may also automatically implement different access configurations without user input, as described herein. As an example, the XR module 420 can implement settings that control/limit remote access to XR features based on granted permissions and otherwise configured permissions and features based on scheduled events. The XR environment and other components of the XR devices can be managed by the XR module 420 according to the configured permissions and features.

In some implementations, the computing platform(s) 402, the remote platform(s) 404, and/or the external resources 424 may be operatively linked via one or more electronic communication links. For example, such electronic communication links may be established, at least in part, via the network 310 such as the Internet and/or other networks. It will be appreciated that this is not intended to be limiting, and that the scope of this disclosure includes implementations in which the computing platform(s) 402, the remote platform(s) 404, and/or the external resources 424 may be operatively linked via some other communication media.

A given remote platform 404 may include client computing devices, such as artificial reality device 302, mobile device 304 tablet 312, personal computer 314, laptop 316, and desktop 318, which may each include one or more processors configured to execute computer program modules. The computer program modules may be configured to enable an expert or user associated with the given remote platform 404 to interface with the system 400 and/or external resources 424, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms. The external resources 424 may include sources of information outside of the system 400, external entities participating with the system 300, and/or other resources. For example, the external resources 424 may include externally designed XR elements and/or XR applications designed by third parties. In some implementations, some or all of the functionality attributed herein to the external resources 424 may be provided by resources included in system 400.

The computing platform(s) 402 may include the electronic storage 426, a processor such as the processors 110, and/or other components. The computing platform(s) 402 may include communication lines, or ports to enable the exchange of information with a network and/or other computing platforms. Illustration of the computing platform(s) 402 in FIG. 4 is not intended to be limiting. The computing platform(s) 402 may include a plurality of hardware, software, and/or firmware components operating together to provide the functionality attributed herein to the computing platform(s) 402. For example, the computing platform(s) 402 may be implemented by a cloud of computing platforms operating together as the computing platform(s) 402.

The electronic storage 426 may comprise non-transitory storage media that electronically stores information. The electronic storage media of the electronic storage 426 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). The electronic storage 426 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 426 may include one or more virtual storage resources (e.g., cloud storage, a virtual private network, and/or other virtual storage resources). The electronic storage 426 may store software algorithms, information determined by the processor(s) 110, information received from computing platform(s) 402, information received from the remote platform(s) 404, and/or other information that enables the computing platform(s) 402 to function as described herein.

The processor(s) 110 may be configured to provide information processing capabilities in the computing platform(s) 402. As such, the processor(s) 110 may include one or more of a digital processor, an analog processor, a digital circuit designed to process information, an analog circuit designed to process information, a state machine, and/or other mechanisms for electronically processing information. Although the processor(s) 110 is shown in FIG. 1 as a single entity, this is for illustrative purposes only. In some implementations, the processor(s) 110 may include a plurality of processing units. These processing units may be physically located within the same device, or the processor(s) 110 may represent processing functionality of a plurality of devices operating in coordination. Processor(s) 110 may be configured to execute modules 408, 410, 412, 414, 416, 418, 420, and/or other modules. Processor(s) 110 may be configured to execute modules 408, 410, 412, 414, 416, 418, 420, and/or other modules by software; hardware; firmware; some combination of software, hardware, and/or firmware; and/or other mechanisms for configuring processing capabilities on the processor(s) 110. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although the modules 408, 410, 412, 414, 416, 418, and/or 420 are illustrated in FIG. 4 as being implemented within a single processing unit, in implementations in which the processor(s) 110 includes multiple processing units, one or more of the modules 408, 410, 412, 414, 416, 418, and/or 420 may be implemented remotely from the other modules. The description of the functionality provided by the different modules 408, 410, 412, 414, 416, 418, and/or 420 described herein is for illustrative purposes, and is not intended to be limiting, as any of the modules 408, 410, 412, 414, 416, 418, and/or 420 may provide more or less functionality than is described. For example, one or more of the modules 408, 410, 412, 414, 416, 418, and/or 420 may be eliminated, and some or all of its functionality may be provided by other ones of the modules 408, 410, 412, 414, 416, 418, and/or 420. As another example, the processor(s) 110 may be configured to execute one or more additional modules that may perform some or all of the functionality attributed below to one of the modules 408, 410, 412, 414, 416, 418, and/or 420.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

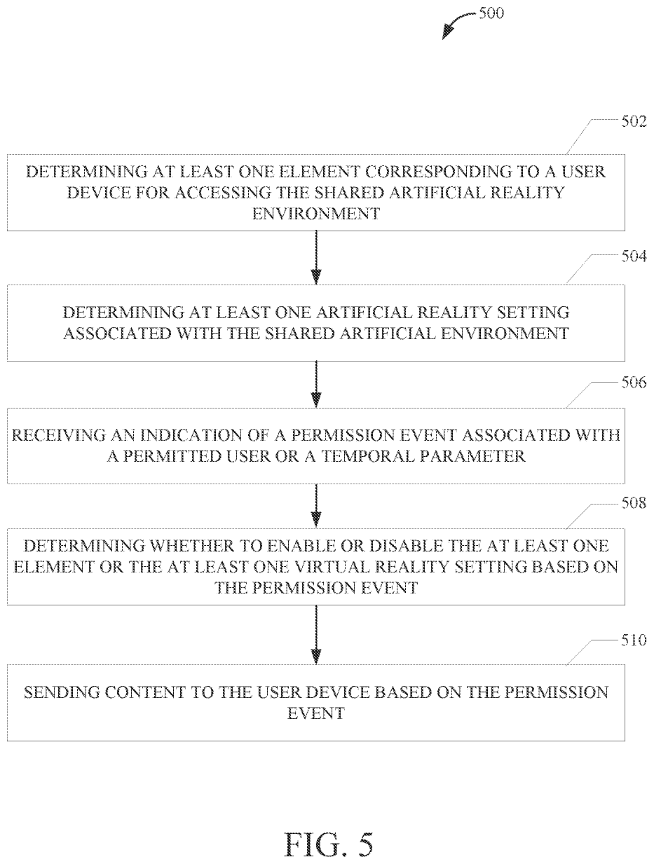

FIG. 5 illustrates an example flow diagram (e.g., process 500) for interaction controls in a shared artificial reality environment, according to certain aspects of the disclosure. For explanatory purposes, the example process 500 is described herein with reference to one or more of the figures above. Further for explanatory purposes, the steps of the example process 500 are described herein as occurring in serial, or linearly. However, multiple instances of the example process 500 may occur in parallel. For purposes of explanation of the subject technology, the process 500 will be discussed in reference to one or more of the figures above.

At step 502, at least one element corresponding to a user device for accessing the shared artificial reality environment for a user may be determined. At step 504, at least one artificial reality setting associated with the shared artificial reality environment may be determined. Artificial reality settings can refer to specific hardware or software features (e.g., lights on an XR device, video communication initiation function on the XR device, etc.) that can be selectively activated or deactivated. At step 506, an indication of a permission event (e.g., permission setting) associated with a permitted user or a temporal parameter may be received. According to an aspect, the permitted user can be a local user or a remote user. At step 508, whether to enable or disable the at least one element or the at least one artificial reality setting may be determined based on the permission event. At step 510, content may be sent to the user device based on the permission event. According to an aspect, the content may include allowable content such as automatic events.

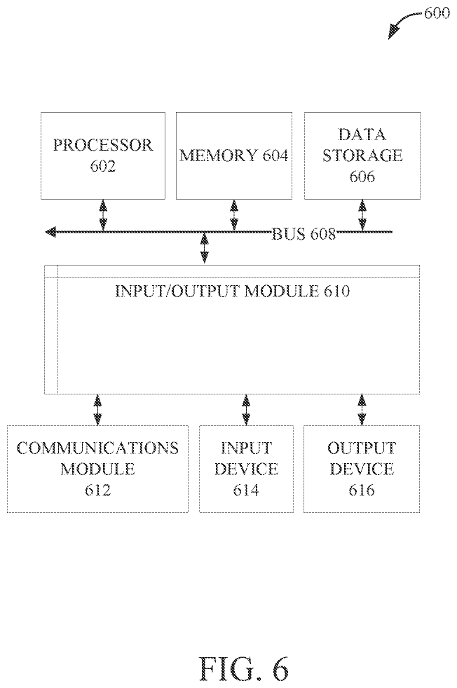

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities.

The computer system 600 (e.g., server and/or client) includes a bus 608 or other communication mechanism for communicating information, and a processor 602 coupled with the bus 608 for processing information. By way of example, the computer system 600 may be implemented with one or more processors 602. Each of the one or more processors 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, metaparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by the processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 600 further includes a data storage device 606 such as a magnetic disk or optical disk, coupled to bus 608 for storing information and instructions. The computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, for displaying information to the user.

According to one aspect of the present disclosure, the above-described systems can be implemented using a computer system 600 in response to the processor 602 executing one or more sequences of one or more instructions contained in the memory 604. Such instructions may be read into memory 604 from another machine-readable medium, such as data storage device 606. Execution of the sequences of instructions contained in the main memory 604 causes the processor 602 to perform the process steps described herein. One or more processors in a multi-processing arrangement may also be employed to execute the sequences of instructions contained in the memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 600 can include clients and servers. A client and server are generally remote from each other and typically interact through a communication network. The relationship of client and server arises by virtue of computer programs running on the respective computers and having a client-server relationship to each other. The computer system 600 can be, for example, and without limitation, a desktop computer, laptop computer, or tablet computer. The computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 602 for execution. Such a medium may take many forms, including, but not limited to, non-volatile media, volatile media, and transmission media. Non-volatile media include, for example, optical or magnetic disks, such as the data storage device 606. Volatile media include dynamic memory, such as the memory 604. Transmission media include coaxial cables, copper wire, and fiber optics, including the wires that comprise the bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads XR data and provides an artificial reality, information may be read from the XR data and stored in a memory device, such as the memory 604. Additionally, data from the memory 604 servers accessed via a network, the bus 608, or the data storage 606 may be read and loaded into the memory 604. Although data is described as being found in the memory 604, it will be understood that data does not have to be stored in the memory 1004 and may be stored in other memory accessible to the processor 1002 or distributed among several media, such as the data storage 1006.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer implemented method comprising:
determining at least one element corresponding to a user device for accessing a shared artificial reality environment;
determining at least one artificial reality setting associated with the shared artificial reality environment;
receiving an indication of a permission event associated with a permitted user or a temporal parameter;
determining whether to enable or disable the at least one element or at least one artificial reality setting based on the permission event; and
sending content to the user device based on the permission event.

2. The computer implemented method of claim 1, further comprising transmitting an activation or deactivation signal comprising at least one feature of the artificial reality environment.

3. The computer implemented method of claim 1, wherein determining whether to enable or disable the at least one element or at least one artificial reality setting based on the permission event comprises determining at least one input restriction for a plurality of user devices compatible with the artificial reality environment.

4. The computer implemented method of claim 3, where the least one input restriction comprises an adjust to facilitate the user device being compatible with the artificial reality environment.

5. The computer implemented method of claim 1, wherein allowable content includes automatic events comprising access to artificial reality features associated with the user device.

6. The computer implement method of claim 1 wherein the access to artificial reality is based on a granted permission.

7. The computer implemented method of claim 1 wherein the at least one element comprises a privacy control sociated with access to the artificial reality setting.

8. The computer implemented method of claim 1, wherein a permission is defined for a shared artificial reality environment.

9. The computer implemented method of claim 1, wherein a remote platform can be configured to cause output of a distinct version of the artificial reality environment.

10. A system for outputting suggestions associated with user attributes, comprising:
one or more processors; and
a memory comprising instructions stored thereon, which when executed by the one or more processors, causes the one or more processors to perform:
determining at least one element corresponding to a user device for accessing a shared artificial reality environment;
determining at least one artificial reality setting associated with the shared artificial reality environment;
receiving an indication of a permission event associated with a permitted user or a temporal parameter;
determining whether to enable or disable the at least one element or at least one artificial reality setting based on the permission event; and
transmitting an activation or deactivation signal comprising at least one feature of the artificial reality environment based on the permission event.

11. The system of claim 10, further comprising a scheduler configured to control a remote access based on parameters comprising temporal parameters, motion parameters, biometric parameters.

12. The system of claim 11, wherein the scheduler is configured to grant permissions asynchronously.

13. The system of claim 10, wherein allowable content includes automatic events comprising access to artificial reality features associated with the user device.

14. The system of claim 10 wherein the permissioned user is a local user.

15. The system of claim 10, wherein the permissioned user is a remote user.

16. The system of claim 10, wherein the at least one element comprises a privacy control sociated with access to the artificial reality setting.

17. The system of claim 10, wherein a permission is defined for a shared artificial reality environment.

18. The system of claim 10, wherein at least one remote platform can be configured to cause output of a distinct version of the artificial reality environment.

19. A non-transitory computer readable medium that stores instructions that, when executed by a processor, cause the processor to perform a method that comprises:
determining at least one element corresponding to a user device for accessing a shared artificial reality environment,
determining at least one artificial reality setting associated with the shared artificial reality environment,
receiving an indication of a permission event associated with a permitted user or a temporal parameter,
determining whether to enable or disable the at least one element or at least one artificial reality setting based on the permission event,
generating a shared artificial reality environment for a plurality of remote users and
sending content to the user device based on the permission event.

20. The non-transitory computer readable medium of claim 19, wherein generating a
shared artificial reality environment for a plurality of remote users comprises automatically implement different access configurations for the plurality of remote users.
